(19) United States
(12) Patent Application Publication
(10) Pub. No.: US 2007/0219953 A1
(43) Pub. Date: Sep. 20, 2007

(54) Searching Content Directories

(75) Inventor: Anthony H. Mak, Epsom (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,809

(22) PCT Filed: Jan. 7, 2005
(86) PCT No.: PCT/IB05/50089

§ 371 Date: Mar. 12, 2007

(30) Foreign Application Priority Data
Jan. 10, 2004 (GB) 0400474.3

(51) Int. Cl. G06F 17/30

(52) U.S. Cl. 707/3

(57) ABSTRACT

A network comprises a plurality of content servers (MS-1-MS-4) which each store media content objects and a directory of descriptive information about the stored media content objects. A control point (CP) in the network queries the servers (MS-1-MS-4) to retrieve descriptive information. The control point (CP) analyses the information to determine which content servers store the same object. Upon receiving a search request, the control point (CP) uses the stored information to determine which content servers in the network need to be queried in order to retrieve the content, or further information about the content. Queries to servers which do not contain relevant content can be reduced or eliminated.

This invention relates to networks in which media content information is distributed across multiple servers and to control point devices for use in such networks.

With an increasing use of digital storage devices to store media content, a home environment will often have a number of different storage devices that a user would like to access. It is desirable to network these together so that a user can, for example, transfer audio files to a portable device, or to view images stored on a digital camera on a large display in the home. For maximum convenience, it is desirable to allow the user to initiate these operations from a variety of user interface (UI) devices. The user interface can be built into the rendering device or it can be another device, such as a wireless personal digital assistant (PDA) or tablet, which also forms part of the network of devices. The media content can range from simple text files to multi-media content such as audio, pre-recorded or user-recorded video, broadcast digital audio (e.g. Internet radio), broadcast digital video or digital images (e.g. digital photos.)

Universal Plug and Play (UPnP) is an example of a communications protocol which allows electronic devices produced by different manufacturers to operate together in this manner. UPnP is designed to support zero-configuration, “invisible” networking, with automatic discovery of new devices. This means a device can dynamically join a network, obtain an IP address, convey its capabilities, and learn about the presence and capabilities of other devices. A further development of UPnP is the UPnP Audio-Visual (AV) Architecture which describes extensions of the UPnP architecture relevant to Audio-Visual devices. The UPnP AV Architecture defines a Media Server, a Media Renderer and a Control Point.

One of the primary parts of the UPnP AV Architecture is the Content Directory Service (CDS). The CDS provides a set of features which allow UPnP Control Point (CP) devices to access the content stored on Media Server (MS) devices. The current publicly available description of CDS is the “Content Directory Service Template Version 1.01” for Universal Plug and Play Version 1.0, Jun. 25, 2002. The Content Directory Service allows clients (e.g. UI devices) to locate individual objects (e.g. songs, movies, pictures) that the server device is capable of providing. For example, this service can be used to provide a list of songs stored on an MP3 player, a list of still-images comprising various slide-shows, a list of movies stored in a DVD Jukebox, a list of songs stored in a CD Jukebox, a list of programs stored on a PVR (Personal Video Recorder) device, etc. Nearly any type of content can be listed via the CDS and multiple types of content (e.g. MP3, MPEG2, JPEG) can be listed together by the CDS.

As described above, a network can include fixed devices, such as a DVD player or hard-disk jukebox, and portable devices, such as a portable media player, digital camera or portable computer.

Within a storage device, content information is stored in a hierarchical structure of UPnP container objects, each container having a collection of objects stored within them. UPnP does not require a Media Server's CDS to be arranged in a particular way and so the way in which containers and objects are arranged is decided by each vendor or user. Consequently, each CDS can have a unique structure and individual objects within the structure may be labelled with different combinations of descriptive metadata. Additionally, UPnP defines two mechanisms by which a CDS can be inspected by a querying device: a “Browse” mechanism by which a querying device can browse through the CDS structure and a more useful “Search” mechanism by which a querying device can request a CDS to return items meeting specified search terms. However, the “Search” mechanism is optional and it is possible that the CDS hosted by a Media Server does not implement UPnP's optional “Search” functionality but instead requires the CP to “Browse” it's hierarchy on a container-by-container basis.

In view of the above, it can sometimes take a considerable time to retrieve information from storage devices on the network, with the control point being required to query every storage device and then to collate the results. A long delay between a user making a query at a user interface and receiving a reply degrades the user's experience of using the system.

US2003/0046703 describes a system for facilitating access to content stored on a private network. Meta information about content stored on each of a number of network devices is aggregated by an aggregator module. The aggregator module acts as a central contact point for all queries and must hold full meta information for all content stored on the network in order to provide an accurate service.

The present invention seeks to improve retrieval of content information in a network.

Accordingly, a first aspect of the present invention provides a method of operating a control point (CP) to perform searching operations in a network (100) comprising the control point (CP) and a plurality of content servers (MS-1-MS-4) for storing a directory of media content objects and descriptive information (CDS) about the stored media content objects, the method comprising:
querying (201, 202) the plurality of content servers (MS-1-MS-4) to retrieve descriptive information about the stored content objects;
analysing the retrieved information to determine which content servers store the same object;
storing (26), for each object, an identifier of each content server storing that object; and,
upon receiving a search request, using the stored information (26) to determine which content servers in the network need to be queried to retrieve further information about the object.

An advantage of storing an identity of each content server is that searches can be performed more efficiently by the control point. The control point need only query those servers which are listed as having the required content. This reduces the overall time of a search, and avoids wasting the limited resources of power (at the control point and the queried content servers) and system bandwidth. This is particularly important where devices have a restricted power supply, such a battery, or the link between the control point and content servers has a limited bandwidth.

In a typical network, objects matching the users search requests are likely to exist only in a small subset of the overall set of servers in the network. Thus, the reduction in the number of server queries can be considerable.

The functionality described here can be implemented in software, hardware or a combination of these. The invention can be implemented by means of hardware or by means of software executed by a processor. Accordingly, another aspect of the invention provides software for performing the method.

It will be appreciated that software may be installed on the control point at any point during the life of the equipment. The software may be stored on an electronic memory device, hard disk, optical disk or other machine-readable storage medium. The software may be delivered as a computer program product on a machine-readable carrier or it may be downloaded directly to the control point via a network connection.

Further aspects of the invention provide a control apparatus for performing the method and a control point incorporating the control apparatus.

Embodiments of the present invention will now be described, by way of example only, with reference to the accompanying drawings, in which:

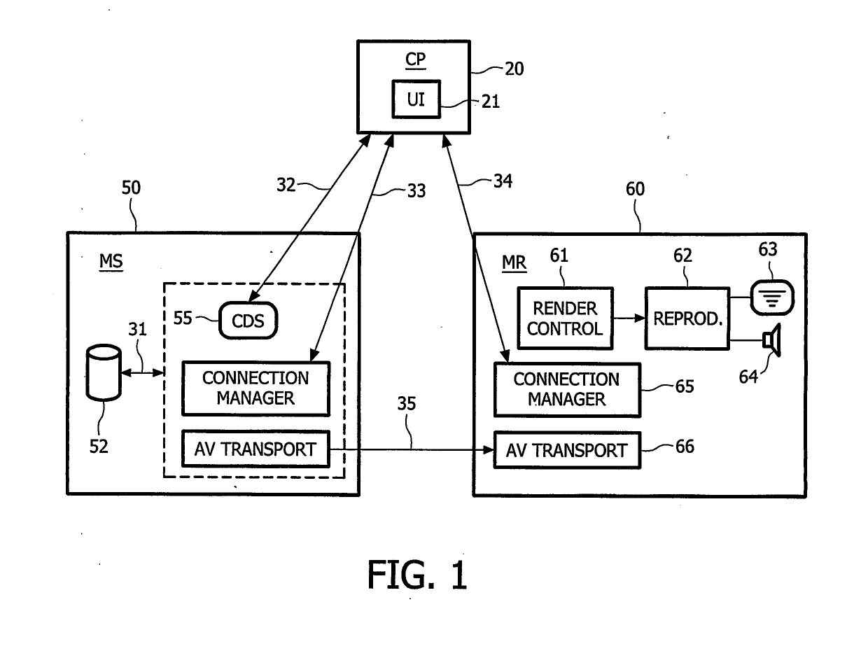

FIG. 1 shows the main components of a UPnP system;

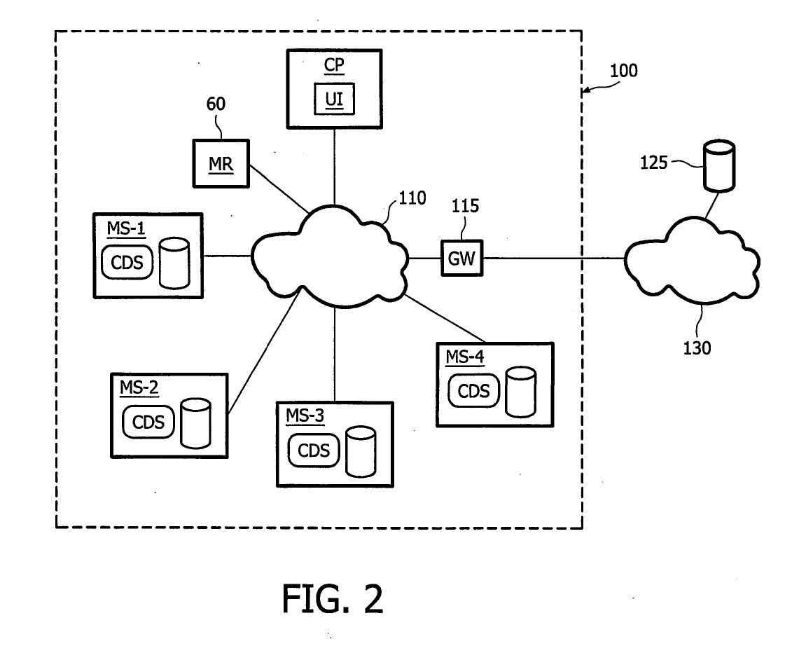

FIG. 2 shows a network of UPnP devices;

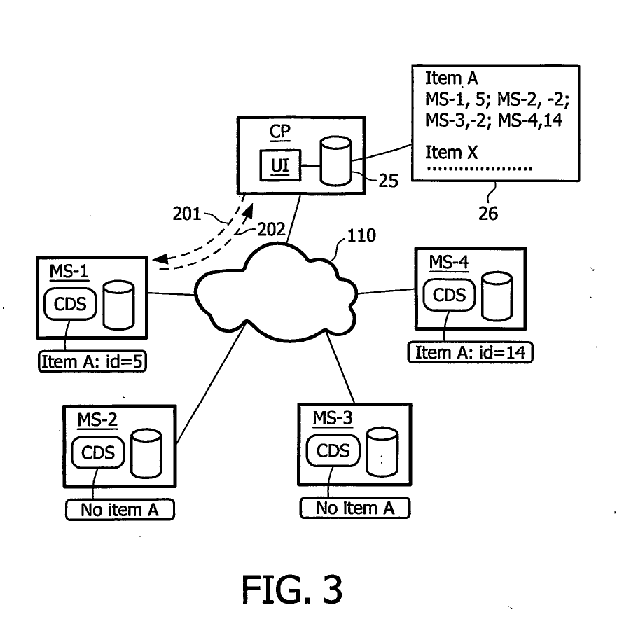

FIG. 3 shows operation of the control point and server devices of FIG. 2;

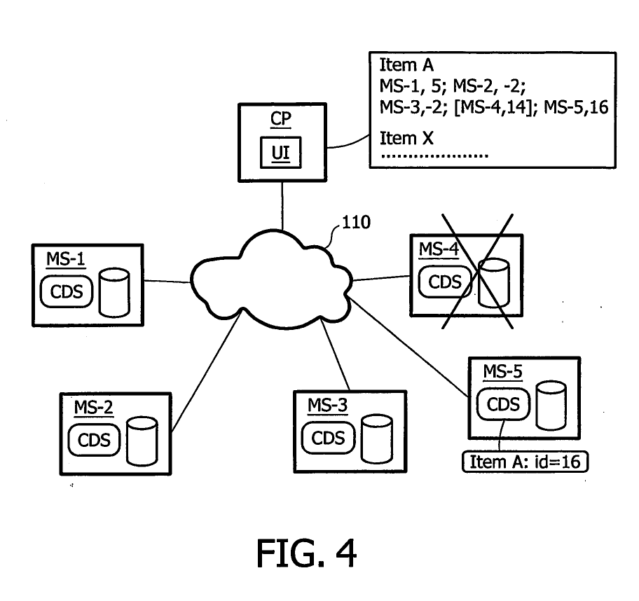

FIG. 4 shows the arrangement of FIG. 3 at a later point in time;

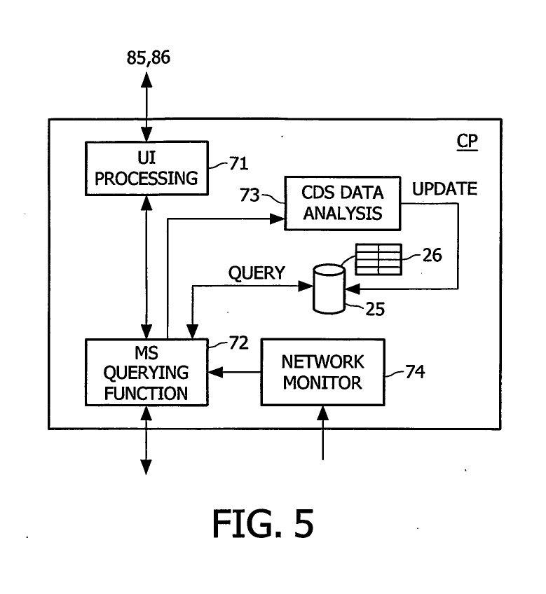

FIG. 5 shows the main functional parts of a control point device; and

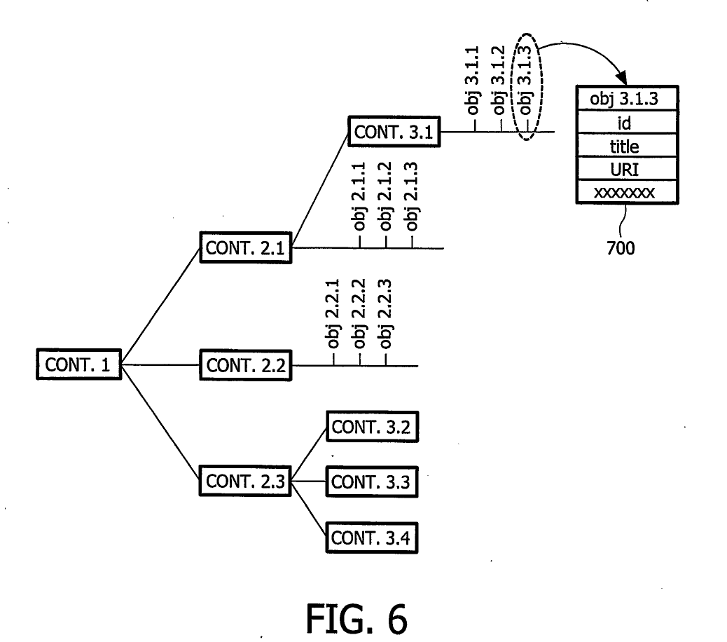

FIG. 6 shows an example structure of a UPnP content directory service.

Before describing the invention in detail, a conventional UPnP system will be briefly described. A more thorough explanation can be obtained from “UPnP AV Architecture” published by the UPnP Forum. The main components of a UPnP AV system are a Control Point (CP) 20, a Media Server (MS) 50 and a Media Renderer (MR) 60. All of these are logical entities: a physical device may include only one of these entities (e.g. a Control Point in the form of a remote control) or, more commonly, a combination of several of these entities. As an example, a CD player comprises a user interface and control circuitry for operating the player (a Control Point), apparatus for reading digital content from an optical disk (a Media Server) and apparatus for converting the digital content into an audio signal for presentation to a user (a Media Renderer).

Media Server (MS) 50 includes a store 52 of media content. The content can include data representing audio, video, still images or a combination of these. The Media Server also supports a Content Directory Service (CDS) 55 which catalogues the content in store 52. The CDS is hierarchically organised in a manner similar to a computer file system. A container (analogous to a folder or directory) can include a plurality of objects (analogous to a file) and containers that are hierarchically one level lower. The object includes an object description with an identifier and other descriptive meta-data. The meta-data may include properties such as object name, artist, composer, date created, size, etc. The object can also include the data representing the actual content, such as an audio file, or it can include a locator, such as a uniform resource indicator (URI), which indicates where the content file can be found. An example CDS structure is shown in FIG. 6. Further functions of the Media Server 50 are a Connection Manager Service which is used to manage connections between the Media Server 50 and other devices, such as the Media Renderer 60. An optional AV Transport Service allows control of the playback of content, with features such as stop, pause, seek etc.

Media Renderer (MR) 60 is responsible for rendering (reproducing) media content which is received from a Media Server 50. Reproduction equipment 62 is shown with a display 63 and speaker 64 although the output can take many forms. Typically, the reproduction equipment 62 includes one or more decoders, digital to analog converter and amplifiers. The Media Renderer 60 also supports a Connection Manager Service 65 for establishing a new connection with a Media Server and Render Control 61 for controlling the way in which the content is rendered. For audio reproduction this can include features such as a volume control.

Control Point (CP) 20 coordinates operation of the Media Server 50 and Media Renderer 60 and includes a user interface (UI) 21 by which a user can select content. The Control Point 20 supports the conventional UPnP mechanisms for discovering new devices and also supports mechanisms for finding the capabilities of Media Rendering devices and establishing connections between a Media Server and a Media Renderer. The UPnP AV Architecture supports a wide variety of AV devices such as TVs, VCRs, CD/DVD players/jukeboxes, set-top boxes, stereo systems, MP3 players, still-image cameras, camcorders, electronic picture frames (EPFs), and the PC. The AV Architecture allows devices to support different types of formats for the entertainment content (such as MPEG2, MPEG4, JPEG, MP3, Windows Media Architecture (WMA), bitmaps (BMP), NTSC, PAL, ATSC, etc.) and multiple types of transfer protocols (such as IEC-61883/IEEE-1394, HTTP GET, RTP, HTTP PUT/POST, TCP/IP, etc.).

Multiple physical devices, each having one or more of the CP, MS and MR entities, can be operated together as a network. FIG. 2 shows an example of a UPnP network which can represent a network of devices within a home. A Control Point CP, four Media Server devices MS-1, MS-2, MS-3, MS-4 and a Media Renderer device MR are networked 110 together. The network 110 can be wired (e.g. Ethernet) or wireless (e.g. IEEE 802.11, Bluetooth). Media content can be wholly located on servers within the home network 100 or it can be located outside the home network 100. FIG. 2 shows a server 125 for storing content which is part of an external network 130, such as the Internet. This external server 125 is connected to the home network via a gateway GW 115.

FIG. 3 shows a simplified version of this network, showing just the control point CP and four media server devices MS-1, MS-2, MS-3, MS-4. The control point CP queries the CDS held by each of the server devices to determine what media content they hold. The querying of server device MS-1 is shown by message flows 201, 202. A query can take the form of a UPnP browse operation, requesting that the server device returns all descriptive meta-data in the CDS, or a request that the server device returns a restricted set of the data, such as titles and local identifiers. In UPnP, each item has an ‘id’ field which uniquely identifies an item within the server device. Each of the server devices MS-1, MS-2, MS-3, MS-4 is queried in this way. All levels of granularity, from high level e.g. ‘music’, ‘video’, ‘images’ or the container object level e.g. music album, through to the lowest level of individual items, e.g. individual music tracks can be queried in this way.

The control point analyses the returned meta-data and aggregates those items that it considers to be the same, or similar. Some of the situations which can cause similarity of content are:
(i) content can be distributed across a number of the server devices, e.g. a particular music album has individual tracks distributed across several servers, or a large video file is divided into several sections that are distributed across several servers;
(ii) content can be duplicated on different servers, e.g. a favorite music album appears, in its entirety, on several servers.

The control point constructs a storage structure which lists each item, the server that it appears on and the local identifier which is used within the server. Referring to FIG. 3, an item of content, which will be called item A, is stored on two of the servers: MS-1 and MS-4. In server MS-1 it has the local id=5 and in server MS-4 it has the local id=14. Item A does not appear on servers MS-2 or MS-3. Item A can represent, for example, a particular music album. A local store 25 on the control point CP stores a data structure 26 which lists the item, the servers it appears on, and the local id on each server. Any other meta-data which was retrieved, and used in the comparison, is discarded.

Those servers which do not store the item are represented by a special result which indicates to the control point that the server does not contain that item. The special result can take various forms. In a preferred embodiment, the special value is a negative value. Negative values are not valid values for the id field in UPnP. The control point is programmed to recognise the occurrence of a negative value as indicating that the item is not present.

All of the above occurs in advance of an actual query by a user. At some later time, a user interacts with user interface UI. Typically, the user interface 21 will present the user with a menu of possible options. As an example, an initial menu screen may ask the user whether they wish to retrieve an audio, video or image. In response to user selections at the UI, the control point CP formulates an appropriate query and submits this to the CDS of server devices MS-1, MS-2, MS-3, MS-4. Because the control point CP maintains a structure 26 of where items are stored, the control point can eliminate redundant searches. If a user requests the Item A, as previously described, the control point CP formulates a query which is sent only to server devices MS-1 and MS-4. As server devices MS-2 and MS-3 are known not to contain anything relevant, they are not queried and redundant searches are eliminated. MS-1 and MS-4 respond with the required information, which will typically be further meta-data for the item, i.e. further meta-data for the selected item which has not been locally stored 25 at the control point. For an example where the requested item is a music track, the further meta-data can represent information such as the artist, genre, release date and lyrics. The information returned by MS-1 and MS-4 can be information from hierarchically lower entries in the CDS. Referring to the CDS structure shown in FIG. 6, if item A represents a music album, shown as container 2.2 (CONT.2.2) this is a container (UPnP class ‘container’:object) which will contain further items (obj 2.2.1, obj 2.2.2, . . . ) representing tracks of the album. The information for the tracks is returned by the query.

When the user selects a piece of content, the CP instructs the MS and the MR to arrange an appropriate connection 33, 34 (FIG. 1) and to begin streaming the content 35 from the MS to the MR, in a conventional manner.

In order that the structure 26 at the control point CP remains a useful tool, it is updated as existing server devices leave the network and new server devices join the network. Server devices may join a network when they are switched on and advertise their presence, as in the discovery process of the UPnP protocol, or when they are brought into the network, as when a portable device is brought into the home. Server devices may leave the network when they are switched off or when a portable device is taken away from the home network. FIG. 4 shows the network of FIG. 3 where server device MS-4 has left the network and a new device MS-5 has joined the network. Considering the again the example of item A, MS-4 stored part of item A. Upon recognising that MS-4 has left the network, the control point CP updates the data structure 26 to indicate that this instance of the item A is unavailable. The entry for MS-4 can be flagged in a way that indicates the unavailability of MS-4 or it can simply be deleted from the data structure. The control point CP recognises that there is a new server device MS-5 and queries this in the same way as before. It recognises that item A appears on MS-5 with the local id=16. This is added to the data structure 26 in store 25. Future queries by a user make use of the updated data structure.

As described above, the control point analyses descriptive meta-data to determine which servers contain the same content. There are various ways of achieving this. An item of content has a set of descriptive meta-data. Some meta-data properties are compulsory while others are optional. In UPnP, compulsory properties include: ‘id’—the identifier of the object within the server; ‘title’—the name of the object and ‘class’—the class of the object. The decision as to whether two objects are the same can be based on:
(i) the objects belong to the same class, i.e. the class name is the same. The class names are defined by the UPnP standards. For example, a music album may be class of, “upnp.container.musicAlbum”. Appendix C of the “Content Directory Service Template Version 1.01”for Universal Plug and Play Version 1.0, Jun. 25, 2002 describes a set of class definitions issued by the UPnP AV Working Committee;
(ii) the objects have similar or the same title (UPnP dc:title field as defined.) The similarity of two titles can be determined by a string comparison, with a requirement for an exact match or a certain degree of similarity.
   Preferably, the decision as to whether two objects are the same is based on both (i) and (ii), i.e. the two objects must belong to the same UPnP class definition and the title of the objects must be the same. However, the criterion or criteria used for comparison can vary according to the class of the object. As an example, a comparison of objects representing broadcast media may be based on a comparison of meta-data representing channel number and broadcast start time.

FIG. 5 shows the main functional blocks of the control point that are relevant to the present invention. A network monitoring function 74 monitors the local network to determine what server devices are present. This function is used during the initial stage of constructing the data structure 26 and in monitoring for when server devices leave or join the network. The network monitor 74 sends updates to the MS querying function 72. This formulates queries, such as browse queries, which are sent to server devices and receives meta-data in reply. Meta-data from multiple devices is sent to the CDS data analysis function 73. This performs the comparison of data to detect similarities between the content of the servers. Updates are sent to the store 25 where a data structure 26 is constructed and maintained. The data structure 26 can be created and maintained using conventional object-oriented programming techniques. A user interface processing function 71 receives user inputs 85, such as selections made on a keyboard, by a mouse or on a touch sensitive screen, and issues outputs 86, such as graphical data for display on a screen and audible prompts. The processing function 71 controls the generation of menus and responds to user selections in a known manner. User selections are sent to the MS querying function 72. The MS querying function 72 makes use of the data held in data structure 26 to determine which servers need to be queried. It then formulates appropriate queries in a suitable format for conveying over the network 100. Similarly, responses received by the querying function 72 are converted into a suitable form for use by the UI processing unit 71.

In the above description, the absence of a particular item in a server is explicitly indicated by a special result. In an alternative embodiment the control point can be arranged to store only those servers which do contain the item. In this alternative scheme the absence of a server in the listing for an item indicates to the control point that the server does not contain the item and should not be searched.

In the above embodiment of the invention, the data structure 26 is created by specially querying server devices. In an alternative embodiment of the invention, results of queries that are performed in response to actual user requests are analysed to derive information for the data structure 26.

It is preferred that the data structure 26 is stored locally to the control point, such as in the working memory of the control point, to minimise any delay in accessing the data. In an alternative embodiment, the data structure is stored on another device in the network 100. It is also possible to maintain the data structure 26 as a service on behalf of multiple control point devices on the network.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in the claim. Where the system/device/apparatus claims recite several means, several of these means can be embodied by one and the same item of hardware.

In the description above, and with reference to the Figures, there is described a network comprising a plurality of content servers (MS-1-MS-4) which each store media content and a directory of descriptive information about the stored media content. A control point (CP) in the network queries the servers (MS-1-MS-4) to retrieve descriptive information. The control point (CP) analyses the information to determine which content servers store the same item. Upon receiving a search request, the control point (CP) uses the stored information to determine which content servers in the network need to be queried in order to retrieve the content, or further descriptive information about the content. Queries to servers which do not contain relevant content can be reduced or eliminated.

1. A method of operating a control point (CP) to perform searching operations in a network (100) comprising the control point (CP) and a plurality of content servers (MS-1-MS-4) for storing a directory of media content objects and descriptive information (CDS) about the stored media content objects, the method comprising:
querying (201, 202) the plurality of content servers (MS-1-MS-4) to retrieve descriptive information about the stored content objects;
analysing the retrieved information to determine which content servers store the same object;
storing (26), for each object, an identifier of each content server storing that object; and,
upon receiving a search request, using the stored information (26) to determine which content servers in the network need to be queried to retrieve further information about the object.

2. A method according to claim 1 further comprising storing (26), for each object, a local identifier of the object within the content server.

3. A method according to claim 1 further comprising storing (26), for each object, an identifier of each content server which does not store that object.

4. A method according to claim 3 further comprising storing (26), for each object, a local identifier of the object within the content server, and wherein those servers which do not store the object have a special value for the local identifier.

5. A method according to claim 4 wherein the special value is a negative value.

6. A method according to claim 1 further comprising updating the stored information (26) according to the availability of servers (MS-1-MS-4) in the network.

7. A method according to claim 6 wherein the stored information (26) is deleted when a server (MS-1-MS-4) is removed from the network.

8. A method according to claim 1 further comprising determining when a new content server joins the network and performing the steps of querying, analysing and storing for the new server.

9. A method according to claim 1 wherein the descriptive information includes classification information, and the step of analysing the retrieved information uses the classification information to determine which content servers store the same object.

10. A method according to claim 1 wherein the step of analysing the retrieved information uses the title of the object to determine which content servers store the same object.

11. A method according to claim 1 wherein the steps of querying, analysing and storing are performed as part of a user-requested search.

12. A method according to claim 1 wherein the step of storing stores information at the control point (CP).

13. A control apparatus for a control point in a network which is arranged to perform the method according to claim 1.

14. Software for causing a processor of a control point in a network to perform the method according to claim 1.

15. A control point comprising the control apparatus according to claim 13.

16. A method, control apparatus, software or control point according to claim 1 wherein the control point is a Universal Plug and Play (UPnP) Control Point and the content servers are UPnP Media Server devices.
